(19) United States
(12) Patent Application Publication
(10) Pub. No.: US 2023/0211532 A1
(43) Pub. Date: Jul. 6, 2023

(54) MOLDING DIE, MOLDING APPARATUS, AND TERMINAL

(71) Applicant: Fulian Yuzhan Precision Technology Co., Ltd., Shenzhen (CN)

(72) Inventors: ZHI-QIANG CHEN, Shenzhen (CN); WEN-WEN HONG, Shenzhen (CN); HUA-ZHONG LIU, Shenzhen (CN); BING CHEN, Shenzhen (CN); XIANG-YONG LIU, Shenzhen (CN); YU-MEI ZHAO, Shenzhen (CN)

(21) Appl. No.: 18/090,399

(22) Filed: Dec. 28, 2022

(30) Foreign Application Priority Data
Dec. 31, 2021 (CN) 202111673430.6
Jul. 11, 2022 (CN) 202210812342.8

(51) Int. Cl. B29C 45/26; B29C 45/14

(52) U.S. Cl. CPC B29C 45/2602; B29C 45/14065; B29C 45/14008; B29C 45/14467; B29C 2033/0005

(57) ABSTRACT

A molding die includes a first mold assembly, a second mold assembly, and a mold core. The first and second mold assemblies are adapted to be clamped together. The mold core defines a molding groove. The molding core is pressed between the first and second mold assemblies to form a molding cavity. The second mold assembly includes a light transmitting area corresponding to the molding cavity, so that the molding cavity will receive incident light through the light transmitting area. In the molding die, the first mold assembly, the second mold assembly, and the mold core cooperate to form the molding cavity, adhesive is injected into the molding cavity, and the molding cavity receives incident light through the light transmitting area, so that curing efficiency of the adhesive is improved, production efficiency is high, shape of molded adhesive is uniform, and product quality is improved.

### CROSS-REFERENCE TO RELATED APPLICATIONS

This application claims all benefits accruing under 35 U.S.C. § 119 from Chinese Patent Application No. 202210812342.8 filed on Jul. 11, 2022, and Chinese Patent Application No. 202111673430.6 filed on Dec. 31, 2021, in the State Intellectual Property Office of China, the entire contents of which are incorporated herein by reference.

### FIELD

The present application generally relates to the technical field of adhesive molding, and particularly to a molding die, a molding apparatus with the molding die, and a terminal.

### BACKGROUND

In the prior art, glue can be used to improve a sealing performance of a product and can also be used to bond two components together. Generally, whether the glue is used for sealing or bonding, a general operation method is to manually apply a layer of glue around a component of the product. If the glue is formed into a single piece, an operation method extrudes the glue into a groove of a fixture and the glue is then naturally cured. The operation efficiency of the two methods is low, the glue often overflows, and the cured glue is uneven and of a different shape, which causes the subsequent assembly to be difficult and affects quality of the product.

### SUMMARY

In view of the above situation, it is necessary to provide a molding die, a molding apparatus with the molding die, and a terminal, to reduce a curing time of an adhesive and improve a curing efficiency of the adhesive.

An embodiment of the present disclosure provides a molding die. The molding die includes a first mold assembly, a second mold assembly, and a mold core. a first mold assembly and a second mold assembly are adapted to be clamped together, and the mold core defining a molding groove. The molding groove is pressed between the first mold assembly and the second mold assembly to form a molding cavity. The second mold assembly has a light transmitting area corresponding to the molding cavity, so that the molding cavity will receive incident light through the light transmitting area.

An embodiment of the present disclosure also provides a molding apparatus. The molding apparatus includes a light source and the molding die as described above, light emitted from the light source irradiates the molding cavity through the light transmitting area.

An embodiment of the present application also provides a terminal. The terminal includes a display screen and an adhesive layer. The adhesive layer is formed on the display screen by injecting the adhesive into the molding die.

In the above molding die, molding apparatus, and terminal, the first mold assembly, the second mold assembly, and the mold core cooperate to form the molding cavity convenient for injection of liquid adhesive, the molding cavity then is received incident light through the light transmitting area, so that curing efficiency of the adhesive is improved, production efficiency is high, shape molded adhesive is uniform, and product quality is improved.

### BRIEF DESCRIPTION OF THE DRAWINGS

FIG. 1 is a stereogram view of a molding die according to some embodiments of the present disclosure.

FIG. 2 is an exploded view of the molding die of FIG. 1.

FIG. 3 is an exploded view of a mold core of the molding die of FIG. 2.

FIG. 4A is a partial cross-sectional view along line IV-IV of the forming mold of FIG. 2.

FIG. 4B is an exploded view of the mold core of FIG. 4A.

FIG. 5 is an exploded view of a second mold assembly of the molding die of FIG. 2.

FIG. 6 is a schematic diagram of assembly of a light guide and a second mold assembly according to some embodiments of the present disclosure.

FIG. 7 is a schematic diagram showing assembly of a light guide and a second mold assembly according to other embodiments of the present disclosure.

FIG. 8 is another exploded view of the second mold assembly of the molding die of FIG. 2.

FIG. 9 is an exploded view of a first mold assembly of the molding die of FIG. 2.

FIG. 10 is a partial cross-sectional view along line X-X of FIG. 1 when the molding die is without an adhesive.

FIG. 11 is another exploded view of the first mold assembly of the molding die of FIG. 2.

FIG. 12 is partial components view of a molding apparatus according to some embodiments of the present disclosure.

FIG. 13 is a flowchart of a manufacturing method of a molding die according to some embodiments of the present disclosure.

FIG. 14 shows a flowchart of steps S10 and S20 in FIG. 13.

FIG. 15 is an exploded view showing injection molding a carrier plate by using an injection mold according to some embodiments of the present disclosure.

FIG. 16 is a flowchart of a bonding method applied to a product according to some embodiments of the present disclosure.

FIG. 17A is a stereogram view of a terminal according to some embodiments of the present disclosure.

FIG. 17B is a partial cross-sectional view along line III-III of the forming mold of FIG. 17A.

### DETAILED DESCRIPTION

The embodiments of the disclosure will be describe in detail below. Examples of the embodiments are shown in the drawings. The same or similar components and the components having same or similar functions are denoted by like reference numerals throughout the descriptions. The embodiments described herein with reference to drawings are explanatory, illustrative, and used to provide understanding of the present disclosure. The embodiments shall not be construed to limit the present disclosure.

In the description of the present disclosure, it is to be noted that the orientations or position relations indicated by terms such as “center”, “longitudinal”, “horizontal”, “length”, “width”, “thickness”, “upper”, “lower”, “front”, “back”, “left”, “right”, “vertical”, “horizontal”, “top”, “bottom”, “inner”, “outer”, and the like are based on orientations or position relations shown in the drawings. These orientations or positional relations are intended merely to facilitate and simplify description of the present disclosure, and not to indicate or imply that a device or component referred to must have such specific orientations or must be configured or operated in such specific orientations. Therefore, these orientations or position relations are not to be construed as limiting the present disclosure. In addition, terms such as “first” and “second” are used herein for purposes of description and are not intended to indicate or imply relative importance or significance or to imply the number of indicated technical features. Thus, the feature defined as “first” and “second” can comprise one or more of this feature. In the description of the present invention, it is to be noted that the term “a plurality of” means two or more than two, unless specified otherwise.

In the description of present disclosure, it should be noted that, unless specified or limited otherwise, the terms “mounted”, “connected”, “coupled”, “fixed” should be understood broadly, and can be, for example, fixed connections, detachable connections, or integral connections; can also be mechanical connections, electrical connections, or mutual communication; can also be direct connections or indirect connections via intervening structures; can also be inner communications of two components, or interaction between two components, which can be understood by those skilled in the art according to specific situations.

Various embodiments and examples are provided in the following description to implement different structures of the present disclosure. In order to simplify the present disclosure, certain components and settings will be described. However, these components and settings are only by way of example and are not intended to limit the present disclosure. In addition, reference numerals and/or letters can be repeated in different examples in the present disclosure. This repeating is for the purpose of simplification and clarity and does not refer to relations between different embodiments and/or settings.

Some embodiments of the present disclosure will be described in detail below in combination with the accompanying drawings.

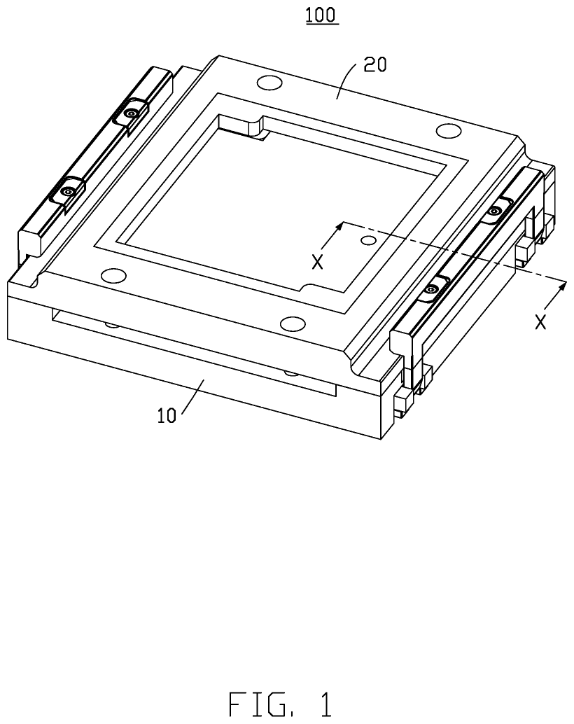

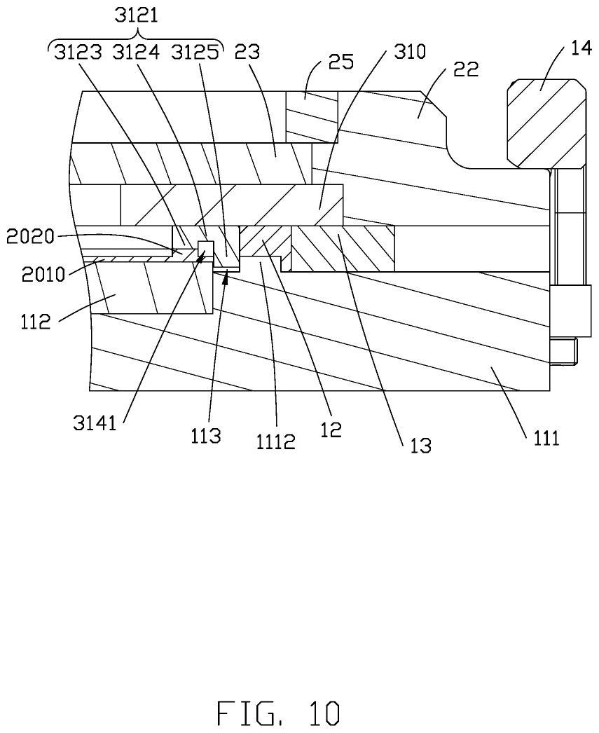

Referring to FIGS. 1 to 3, some embodiments of the present disclosure disclose a molding die 100. An adhesive 3000 can be injected into the molding die 100 to be formed into a component. The molding die 100 can be configured to clamp a product to receive adhesive, and the adhesive 3000 can be injected into the molding die 100 to adhere to the product after being cured. The product to receive adhesive can be a component, a semi-finished product, or a finished product. A molding cavity 3141 (shown in FIG. 10) of the molding die 100 is pressed against a surface of the product, so that the injected adhesive 3000 can adhere to a periphery or any side of the product surface, to improve the sealing and waterproofing of the product. Certainly, the adhesive 3000 can also be formed into a protrusion, such as a column, on the product, so that it can be located and fixed into other components. The product to receive adhesive can include two objects stacked on or spaced apart from each other, such as two components, two semi-finished products, or two finished products. The product to receive adhesive can also include one component and one semi-finished product which are stacked on or spaced apart from each other. The adhesive 3000 is applied onto the sides of two different objects, to bond the two objects. The adhesive 3000 can also be applied on a side of one object only and extend to a surface of another object, so that a periphery of one object is bonded to the surface of another object.

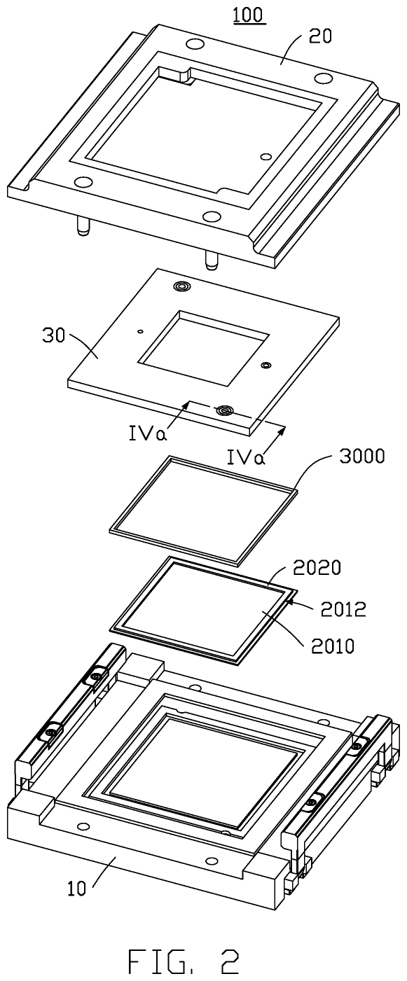

Referring to FIGS. 2, 3, and 10, the molding die 100 includes a first mold assembly 10, a second mold assembly 20, and a mold core 30.

The first mold assembly 10 and the second mold assembly 20 are adapted to be clamped together. The mold core 30 defines a molding groove 3122, the mold core 30 is pressed between the first mold assembly 10 and the second mold assembly 20 to form a molding cavity 3141. The second mold assembly 20 has a light transmitting area corresponding to the molding cavity 3141, so that the molding cavity 3141 is received incident light through the light transmitting area. The molding cavity 3141 is configured to contain the adhesive 3000 which is injected. The adhesive 3000 includes an organic adhesive and/or an inorganic adhesive.

To facilitate understanding, description is given by using an example in which the product to receive adhesive includes two stacked objects, one large and one small. Furthermore, description is given by using an example in which the two objects are a display screen 2010 and a connecting bracket 2020. The connecting bracket 2020 is configured to connect with other components to form a terminal during subsequent assembling. In this embodiment, a length and a width of the connecting bracket 2020 are less than a length and a width of the display screen 2010, so that a bonding area 2012 to carry the adhesive 3000 is formed on a surface of the display screen 2010. The adhesive 3000 will form an adhesive layer after being cured.

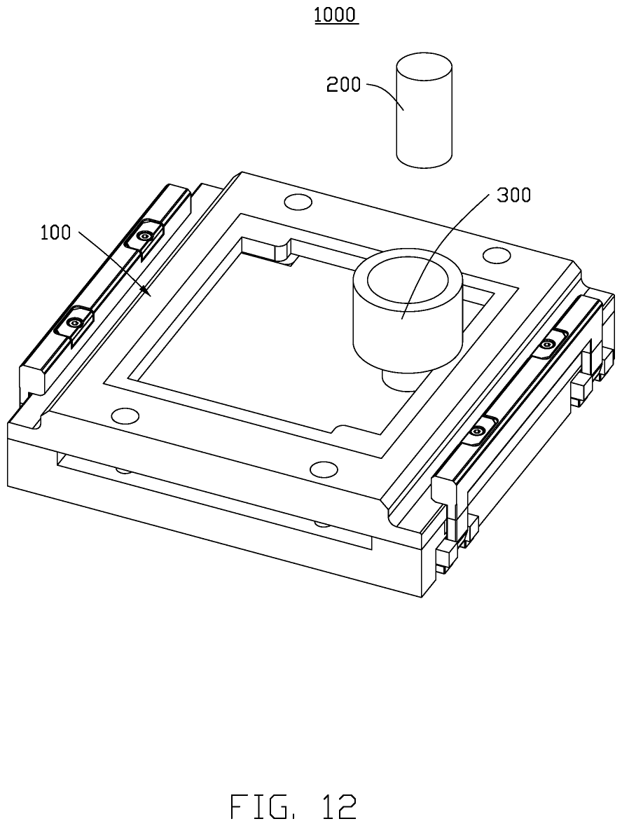

In some embodiments, an assembly process of the molding die 100 is performed as follows. First, the mold core 30 is mounted on the second mold assembly 20. Then, the connecting bracket 2020 and the display screen 2010 are mounted on the mold core 30. Then, the first mold assembly 10 and the second mold assembly 20 are clamped together to press against the molding groove 3122, so that the bonding area 2012 of the display screen 2010 and one surface of the connecting bracket 2020 cooperatively cover the molding groove 3122 to seal the molding groove 3122. Then, the first mold assembly 10 and the second mold assembly 20 are inverted, so that the first mold assembly 10 is below the second mold assembly 20. Then, the adhesive 3000 are injected into the molding cavity 3141 until the adhesive 3000 infills the molding cavity 3141. Then, a light source 200 (shown in FIG. 12) is powered on, light emitted from the light source 200 irradiates the molding cavity 3141 through the light transmitting area to illuminate the adhesive 3000 in the molding cavity 3141, to cure the adhesive 3000 and create an adhesive layer. Then, the light source 200 is powered off, the first mold assembly 10 and the second mold assembly 20 are separated from each other, and the display screen 2010 and the connecting bracket 2020 which are connected through the adhesive 3000 are taken out. In this way, the connecting bracket 2020 and the display screen 2010 are connected by the cured adhesive 3000. After curing, shape of adhesive 300 is uniform, which facilitates the subsequent assembly of the product with other components and improves the quality of the product. The adhesive 3000 can be quickly cured under the light, improving the production efficiency, reducing the curing time of the adhesive 3000, saving the production time, and reducing the production cost.

In other embodiments, the assembly of the molding die 100 can also be done by first mounting the connecting bracket 2020 and the display screen 2010 on the mold core 30, then mounting the mold core 30 on the first mold assembly 10, and then clamping the first mold assembly 10 and the second mold assembly 20 together. In other embodiments, the assembly of the molding die 100 can also be done by first mounting the connecting bracket 2020 and the display screen 2010 on the first mold assembly 10, then covering the mold core 30 with the display screen 2010, and then clamping the first mold assembly 10 and the second mold assembly 20 together. It can be understood that, when the molding die 100 is used, a contour of the molding groove 3122 can be designed according to requirement of users for the adhesive 3000 (including molding into a component by using the adhesive 3000, bonding more than two objects by using the adhesive 3000, or sealing a product by using the adhesive 3000), and the shape of the molding cavity 3141 can be designed according to the requirement of the users. For example, when it is necessary to mold the adhesive 3000 into a component, the molding groove 3122 can fit with the second mold assembly 20 to form the molding cavity 3141. Optionally, the molding groove 3122 can also fit with the first mold assembly 10 and the second mold assembly 20 together to form the molding cavity 3141. When it is necessary to bond more than two independent objects or seal a product (including a plurality of connected objects), the molding groove 3122 can tightly fit with the product to form the molding cavity 3141. The molding cavity 3141 can be formed according to needs of the users, a manner of forming the molding cavity 3141 is not limited in the disclosure.

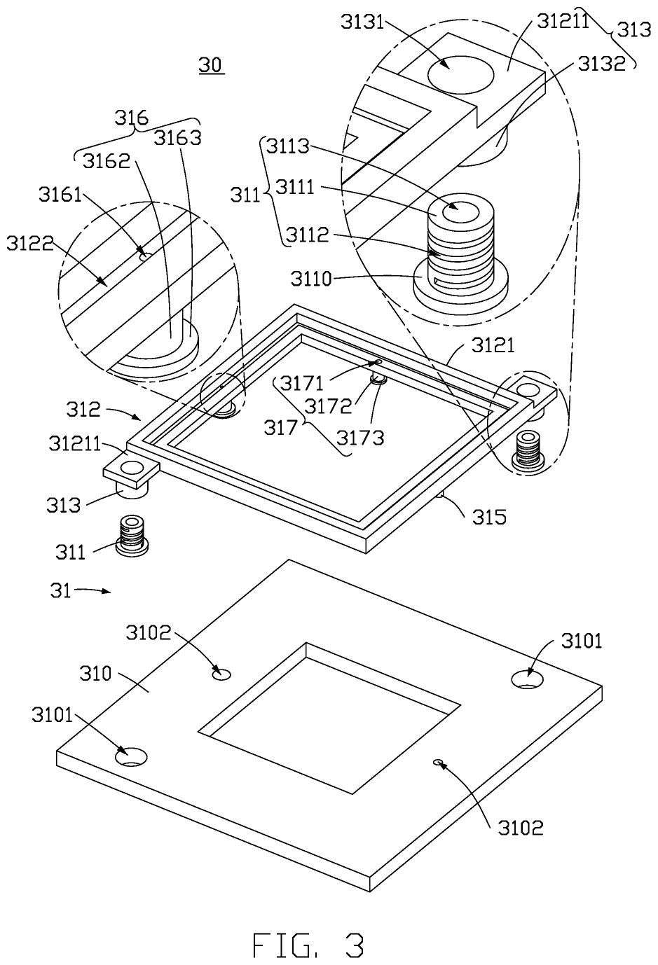

Referring to FIG. 3, in some embodiments, the mold core 30 includes a carrier plate 31 and a molding member 312. Both the carrier plate 31 and the molding member 312 can be substantially annular. A size of the carrier plate 31 is larger than that of the molding member 312. The carrier plate 31 supports the molding member 312. The carrier plate 31 is arranged between the first mold assembly 10 and the second mold assembly 20, the molding member 312 is connected to the carrier plate 31, and the molding groove 3122 is defined in a side of the molding member 312 facing away from the carrier plate 31. Therefore, the carrier plate 31 can effectively support the molding member 312 with the molding groove 3122, ensuring that the molding cavity 3141 is not easily deformed after being filled with adhesive 3000, and ensuring the accuracy of the shape of the cured adhesive 3000.

It can be understood that, in other embodiments, the carrier plate 31 can also be sheet-shaped or strip-shaped. When the carrier plate 31 is annular, it can be continuously annular or discontinuously annular. In some embodiments, the carrier plate 31 includes a light transmitting plate 310 and a positioning sleeve 311. The light transmitting plate 310 has high light translucency. The light transmitting plate 310 is substantially annular and is arranged between the first mold assembly 10 and the second mold assembly 20, and the molding member 312 is arranged on the light transmitting plate 310. The positioning sleeve 311 is arranged on the light transmitting plate 310 and connected with the molding member 312. Therefore, the positioning sleeve 311 facilitates the assembly of the light transmitting plate 310 and the molding member 312. The carrier plate 31 can be formed by injection molding, and the carrier plate 31 can be made of soft material such as silica gel or plastic.

In some embodiments, the light transmitting plate 310 can be made of a light-transmissive material selected from glass, light transmitting stone, acrylic, silica gel, or the like. Two injection molding holes 3101 are arranged at the two ends of a diagonal line across the light transmitting plate 310. The molding part 312 can be made of silica gel which is light-transmissive. A number of positioning sleeves 311 can be two, the two positioning sleeves 311 are arranged in the injection molding holes 3101, and the molding member 312 is connected with the two positioning sleeves 311. The glass can be quartz glass, organic glass, etc.

It can be understood that the number of the positioning sleeves 311 can also be one, three, four, or more.

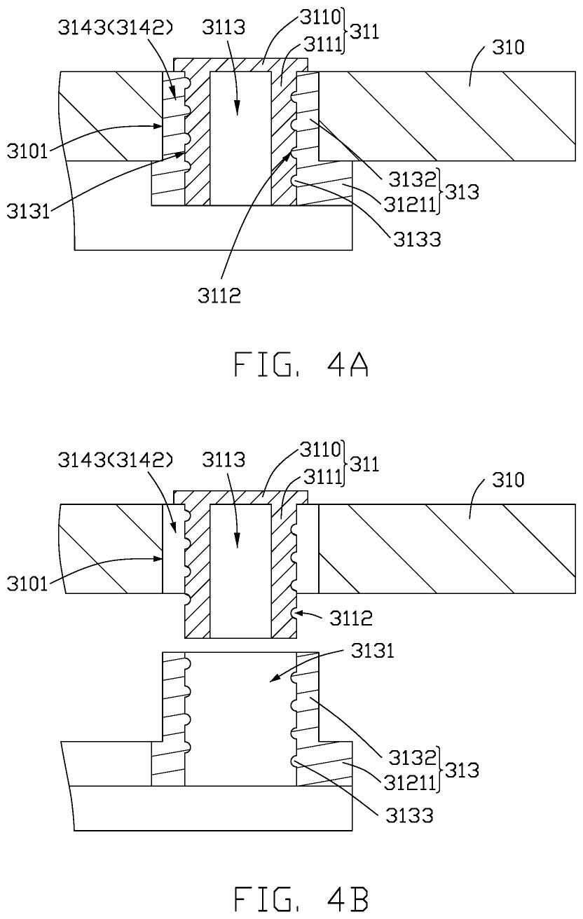

Referring to FIGS. 3 and 4A, in some embodiments, the molding member 312 includes a molding main body 3121 and a positioning portion 313. The molding main body 3121 is defined in a side of the light transmitting plate 310, and the molding groove 3122 is defined in a side of the molding main body 3121 facing away from the light transmitting plate 310. A number of positioning portions 313 is equal to the number of the injection molding holes 3101, and the number of the positioning portions 313 is two. The two positioning portions 313 protrude from two diagonally-opposite corners of the molding main body 3121 and are connected to the light transmitting plate 310. Each positioning portion 313 defines a positioning hole 3131. Each positioning sleeve 311 can be arranged to fit in a corresponding positioning hole 3131, and the positioning portion 313 is at least partially within a corresponding injection molding hole 3101. In this way, by using the positioning portion 313, the connection between the light transmitting plate 310, the positioning sleeve 311, and the molding member 312 in assembly, is achieved. Understandably, when the positioning sleeve 311 is assembled into the injection molding hole 3101, as shown in FIG. 4B, an injection molding gap 3142 is formed between the positioning sleeve 311 and the injection molding hole 3101, and the positioning portion 313 can be formed by injection molding in the injection molding gap 3142.

Referring to FIG. 3, in some embodiments, the light transmitting plate 310 defines at least one clamping hole 3102. The molding member 312 also includes a clamping member 315 connected with the molding main body 3121, a number of clamping members 315 is equal to a number of clamping holes 3012, and the clamping members 315 fits in the clamping holes 3012. Each clamping member 315 can protrude from a side of the molding main body 3121 and is arranged to fit in the clamping hole 3102. In this way, the clamping member 315 is connected with the clamping hole 3102, so that the connection between the molding member 312 and the light transmitting plate 310 is stronger, and the molding member 312 is not easily separated from the light transmitting plate 310.

It can be understood that in other embodiments, the clamping member 315 can also protrude from a surface of the molding main body 3121.

In some embodiments, the molding member 312 formed by the molding main body 3121, the positioning portion 313, and the clamping member 315 can be formed by injection molding. Injection molding is a technique which is simple and fast, facilitating the stable connection of the molding member 312 with the light transmitting plate 310 and the positioning sleeve 311.

It can be understood that in other embodiments, the molding member 312 can also be connected with the light transmitting plate 310 and the positioning sleeve 311 in other ways. For example, after the molding member 312 is formed by injection molding, the positioning portion 313 and the clamping member 315 of the molding member 312 are inserted into the injection molding hole 3101 and the clamping hole 3102 of the light transmitting plate 310, and then the positioning sleeve 311 is inserted into the positioning hole 3131 of the positioning portion 313. In this way, the molding member 312 becomes attached with the light transmitting plate 310 and the positioning sleeve 311.

In some embodiments, the positioning portion 313 includes a positioning main body 3132 and a positioning cap 31211. The positioning main body 3132 is substantially cylindrical. The positioning main body 3132 protrudes from the molding main body 3121 and is arranged in the injection molding hole 3101 to connect with the light transmitting plate 310. The positioning cap 31211 is substantially circular. The positioning cap 31211 is connected with the positioning main body 3132. The positioning hole 3131 penetrates the positioning main body 3132 and the positioning cap 31211. In this way, the positioning cap 31211 allows the molding member 312 to be snap-fitted to the light transmitting plate 310, the connection between the molding member 312 and the light transmitting plate 310 is stronger, and the molding member 312 is not easily separated from the light transmitting plate 310.

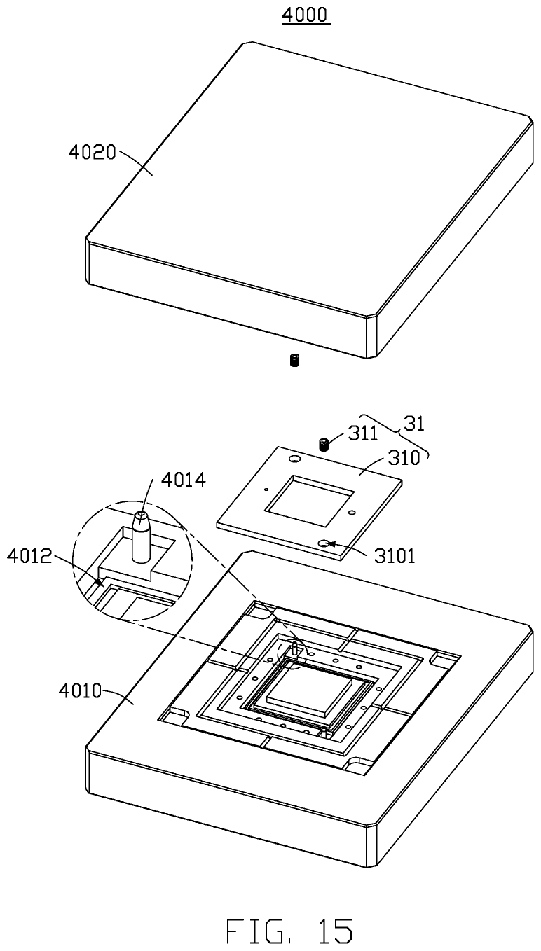

The positioning sleeve 311 is matched with the positioning portion 313. The positioning sleeve 311 includes a positioning sleeve body 3111 and a sleeve cap 3110. The positioning sleeve body 3111 is substantially cylindrical, and the positioning sleeve body 3111 is arranged to fit in the positioning hole 3131 of the positioning main body 3132. The sleeve cap 3110 is substantially cone-shaped, is arranged to fit in the positioning hole 3131 of the positioning cap 31211, and is connected with the positioning sleeve body 3111. It can be understood that, when the sleeve cap 3110 is substantially conical, the positioning hole 3131 of the positioning cap 31211 will also be substantially conical. Referring to FIG. 4B, it can be understood that when the positioning sleeve 311 is assembled with the injection molding hole 3101, a third injection molding gap 3143 is formed between the positioning sleeve body 3111 of the positioning sleeve 311 and the injection molding hole 3101, the positioning sleeve 311 also forms a fourth injection molding gap (not shown) with an injection cavity 4012 (shown in FIG. 15) of an outside injection mold 4000 (shown in FIG. 15) and the light transmitting plate 310. In some embodiments, the positioning main body 3132 and the positioning cap 31211 of the positioning portion 313 can be formed in the third injection molding gap 3143 and the fourth injection molding gap, by injection molding.

It can be understood that in other embodiments, the sleeve cap 3110 can also be cylindrical or the like, and the positioning hole 3131 of the positioning cap 31211 is matched with the sleeve cap 3110.

It can be understood that in other embodiments, the positioning cap 31211 and the sleeve cap 3110 can also be canceled.

Referring to FIG. 3, in some embodiments, the molding member 312 further includes at least one injecting portion 316. The injecting portion 316 is arranged on the molding main body 3121, and the injecting portion 316 defines an injecting hole 3161 which is in fluid communication with the molding groove 3122. The injecting hole 3161 can be a straight hole, a curved hole, a bent hole, or the like. In this way, the adhesive 3000 is injected into the molding cavity 3141 through the injecting portion 316 and the injecting hole 3161. A shape of the injecting hole 3161 is not limited in the present disclosure, so that the adhesive can be injected into the molding cavity 3141 from any direction, improving the applicability of the molding die 100. For example, the inserting hole 3161 can be substantially L-shaped, so that the adhesive 3000 can be injected into the molding cavity 3141 in a direction parallel to the light transmitting plate 310.

In some embodiments, the injecting portion 316 includes an injecting main body 3162 and an injecting cap 3163, and the injecting hole 3161 penetrates the injecting main body 3162 and the injecting cap 3163. The injecting cap 3163 and the molding main body 3121 are snap-fitted to the upper and lower surfaces of the light transmitting plate 310, and the injecting main body 3162 penetrates the molding main body 3121. In this way, the injecting main body 3162 and the injecting cap 3163 allow the light transmitting plate 310 to support the injecting portion 316, ensuring smooth flow of the adhesive 3000 when injected. It can be understood that in other embodiments, the injecting cap 3163 can be canceled.

It can be understood that in other embodiments, the product can be mounted in the molding die 100 by injecting the adhesive 3000 first and then assembling. For example, the adhesive 3000 is injected into the molding groove 3122 through the injecting portion 316 first, and then the product, the first mold assembly 10, the second mold assembly 20, and the molding die 30 are assembled. In this way, the injecting portion 316 can be canceled.

In some embodiments, the molding member 312 also includes at least one overflow portion 317. The overflow portion 317 is arranged on the molding main body 3121, and the overflow portion 317 defines an overflow hole 3171 which is in fluid communication with the molding groove 3122. The overflow hole 3171 can be a straight hole, a curved hole, a bent hole, or the like. In this way, the overflow portion 317 and the overflow hole 3171 allow an excess of adhesive 3000 to overflow when the molding cavity 3141 is filled up the adhesive 3000, which is a convenient indicator for an operator to see that the molding cavity 3141 has been filled with the adhesive 3000. In some embodiments, the overflow portion 317 includes an overflow main body 3172 and an overflow cap 3173, and the overflow hole 3171 penetrates the overflow main body 3172 and the overflow cap 3173. The overflow cap 3173 and the molding main body 3121 are snap-fitted to the upper and lower surfaces of the light transmitting plate 310, and the overflow main body 3172 penetrates the molding main body 3121. In this way, the light transmitting plate 310 supports the overflow portion 317 through the overflow main body 3172 and the overflow cap 3173, ensuring the smooth outflow of the adhesive 3000 when overflows.

It can be understood that in other embodiments, it is also possible to confirm whether the molding cavity 3141 is filled up the adhesive 3000 by detecting a pressure of glue. During glue filling, it can be observed whether the pressure reaches a preset value to confirm that the adhesive 3000 has fully filled the molding cavity 3141. In this way, the overflow portion 317 can be canceled.

Referring to FIG. 4A, in some embodiments, an outside surface of the positioning sleeve 311 defines an engagement groove 3112. It can be understood that an outside surface of the positioning sleeve body 3111 defines the engagement groove 3112. A side wall of the positioning hole 3131 defines an engagement protrusion 3133. It can be understood that the side wall of the positioning hole 3131 of the positioning portion 313 defines the engagement protrusion 3133. The engagement groove 3112 can engage with the engagement protrusion 3133. In this way, the engagement groove 3112 is connected precisely with the engagement protrusion 3133, so that the connection between the positioning sleeve 311 and the positioning portion 313 becomes stronger, preventing the positioning sleeve 311 from moving up and down relative to the positioning portion 313.

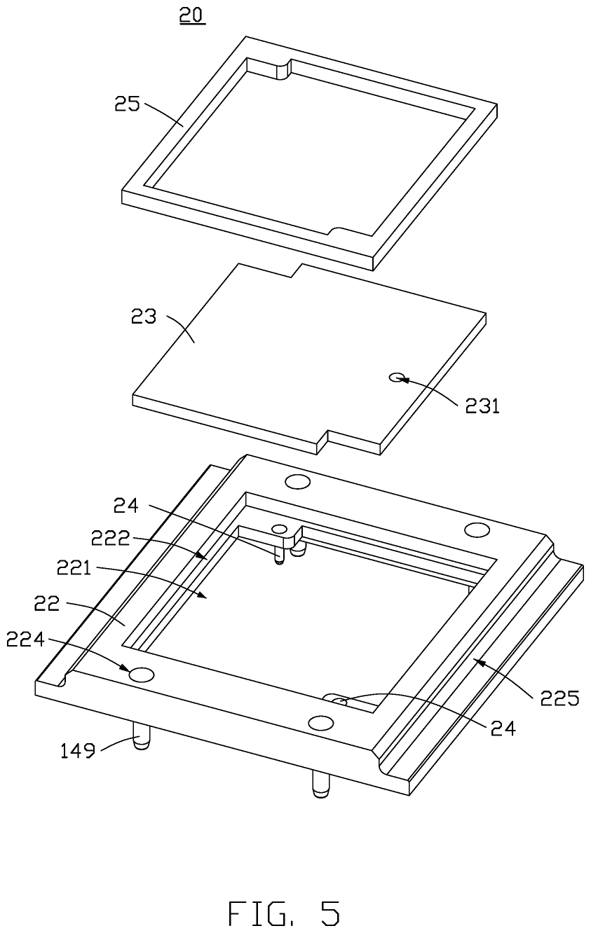

Referring to FIG. 5, in some embodiments, the second mold assembly 20 includes a second mold 22, a light guide 23, and a positioning member 24. The second mold 22 defines a through hole 221, and the second mold 22 can be substantially annular. The light guide 23 is arranged in the through hole 221 and is made of light transmitting materials. The light guide 23 acts as the above light transmitting area. In other embodiments, the light guide 23 can be canceled. At this time, the through hole 221 itself can act as the above light transmitting area.

Referring to FIG. 3, the positioning sleeve 311 defines an insertion hole 3113, the insertion hole 3113 penetrates the positioning sleeve body 3111 and the sleeve cap 3110. The positioning member 24 is inserted through the second mold 22 first and then the insertion hole 3113 of the positioning sleeve 311, so that the mold core 30 can be accurately assembled on the second mold 22. The positioning member 24 is substantially rod-shaped. The number of positioning members 24 is equal to the number of locating sleeves 311, and the positioning members 24 are disposed to correspond to the positioning sleeves. An end of each positioning member 24 can be fixed on the second mold 22. In this way, the positioning member 24 enables the mold core 30 to be accurately assembled on the second mold 22 through the positioning members 24, improving assembly accuracy of the mold core 30 and the second mold 22.

In some embodiments, the second mold assembly 20 also includes a shim (not shown) matching the positioning member 24. For example, an end of the positioning member 24 away from the second mold 22 has an outside thread, and the shim can have a suitable inside thread. After the mold core 30 is connected with the positioning member 24 through the positioning sleeve 311, it is connected and fixed with the positioning member 24 through the shim to further secure the mold core 30.

In some embodiments, the light guide 23 may be sheet-shaped. In this way, the light guide 23 is disposed in the through hole 221. Therefore, the first mold assembly 10 and the second mold assembly 20 can be sealed by the light guide 23, preventing impurities such as dust from entering the molding cavity 3141 through the through hole 221 to contaminate the adhesive 3000.

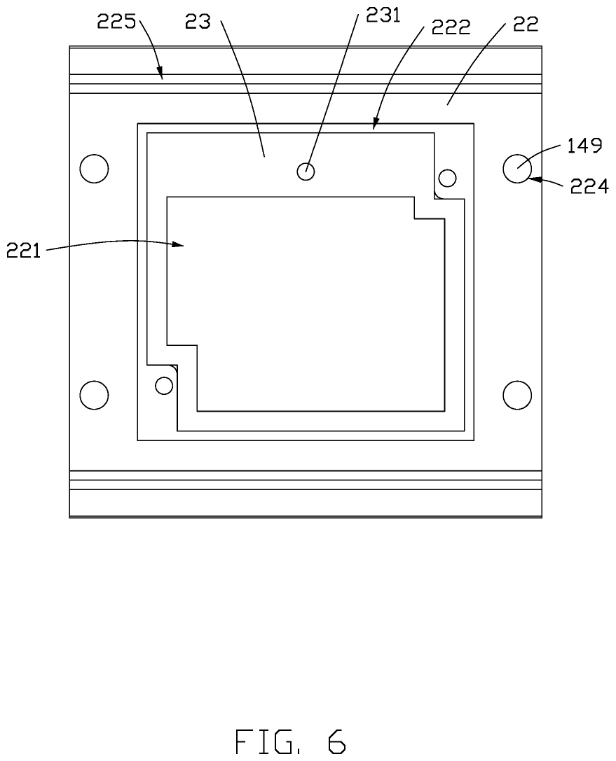

Referring to FIG. 6, in some embodiments, the light guide 23 can also be annular. In this way, light is guided to the molding groove 3122 only by the annular light guide 23, thereby saving material of the light guide 23, saving cost of the mold. It can be understood that the light guide 23 may be a continuous or discontinuous ring. It should be noted that when the light guide 23 is annular, the light transmitting plate 310 can be sheet-shaped, so that impurities such as dust can be prevented from entering the molding cavity 3141 from the through hole 221 to contaminate the adhesive 3000.

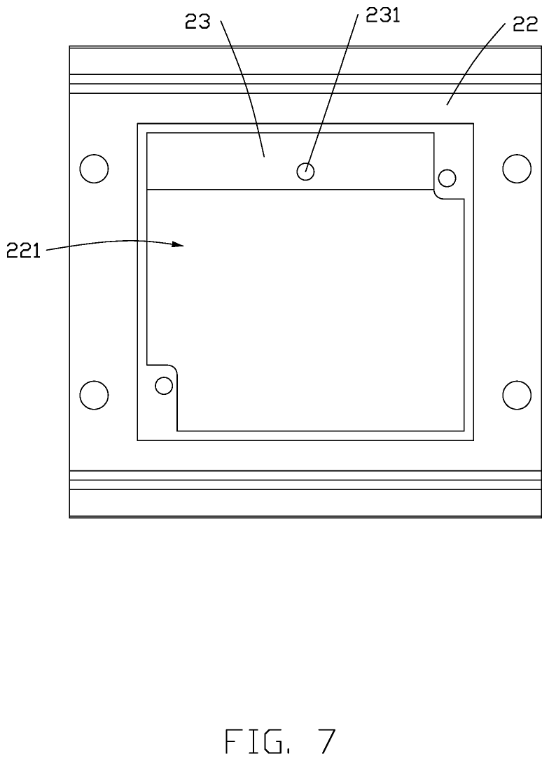

Referring to FIG. 7, in some embodiments, the light guide 23 can also be strip-shaped. In this way, light is guided to one groove of the frame-shaped molding groove 3122 only by the strip-shaped light guide 23, so that the adhesive 3000 in the molding cavity 3141 can be selectively cured, saving the material of the light guide 23, saving the cost. It should be noted that when the light guide 23 is in a strip shape, the light transmitting plate 310 can be in a sheet shape, so that impurities such as dust can be prevented from entering the molding cavity 3141 from the through hole 221 to contaminate the adhesive 3000.

Referring to FIG. 5, in some embodiments, the second mold assembly 20 further includes a pressing plate 25. The pressing plate 25 is substantially annular. The pressing plate 25 is arranged on a side of the second mold 22 facing away from the first mold assembly 10, and presses against at least a part of a periphery of the light guide 23. In this way, the light guide 23 presses against the pressing plate 25, so that the light guide 23 is fixed in the through hole 221, ensuring the stability of the light transmission area during use. The pressing plate 25 is arranged to be substantially circular, so the pressing plate 25 does not block the light, so that the light can irradiate the light guide 23, the utilization rate of light is improved.

It can be understood that in another embodiment, the pressing plate 25 can also be plate-shaped or strip-shaped. When the pressing plate 25 is plate-shaped, the pressing plate 25 has a high light translucency, so that light can pass through the pressing plate 25 and irradiate the light guide 23. When the pressing plate 25 is strip-shaped, the number of pressing plates 25 can be one, two, three, or more.

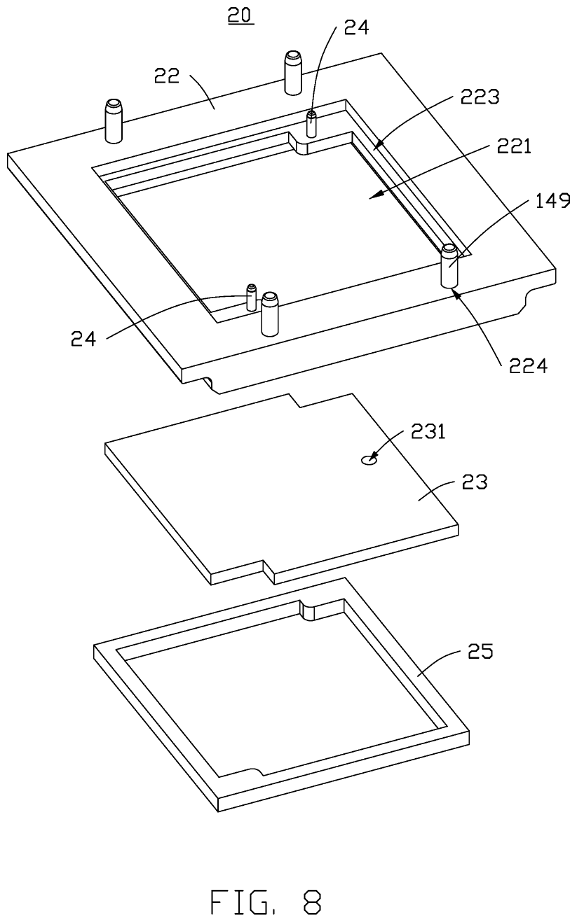

Referring to FIG. 8, in some embodiments, the opposite upper and lower surfaces of the second mold 22 respectively define a first groove 222 and a second groove 223, and the first groove 222 communicates with the second groove 223 by a through hole 221. The pressing plate 25 is arranged to fit in the first groove 222, and a surface of the pressing plate 25 facing away from a bottom of the first groove is substantially flush with a surface of the second mold 22 facing away from the first mold assembly 10. An end of the positioning member 24 is connected with a bottom of the second groove 223. Optionally, the end of positioning member 24 is rotationally connected with the bottom of the second groove 223. The positioning member 24 is matched with the positioning hole 3131, so that the mold core 30 is arranged to fit in the second groove 223. After the product is assembled on the mold core 30, a surface of the product facing away from the mold core 30 is substantially flush with a surface of the second mold 22 facing the first mold assembly 10. In this way, the first groove 222 and the second groove 223 are arranged to prevent the pressing plate 25 and the assembled product protruding from the upper and lower surfaces of the first mold, which is conducive to reducing a thickness of the assembled molding die 100.

It can be understood that in other embodiments, at least one of the first groove 222 and the second groove 223 can be canceled. The second mold 22 is thus easily manufactured.

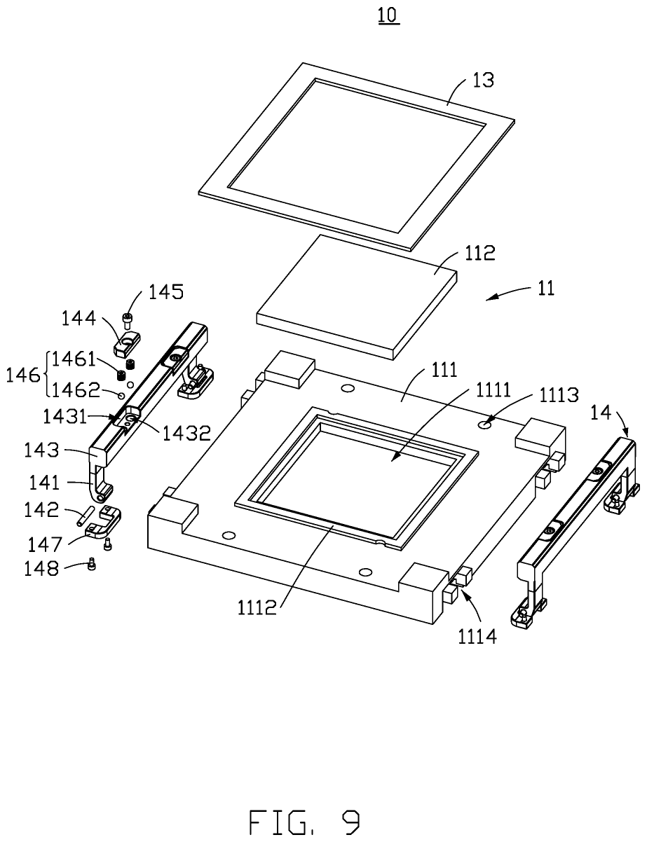

Referring to FIG. 9 and FIG. 10, in some embodiments, the first mold assembly 10 includes a first mold 11. The first mold 11 is configured to support the product and the molding member 312, and the first mold 11 can be clamped to fit with the second mold 22.

The first mold assembly further includes a resisting member 12, the resisting member 12 is substantially annular. The resisting member 12 is disposed between the first mold 11 and the second mold 22 and resists against the molding member 312 and the light transmitting plate 310. In this way, the resisting member 12 is arranged to be annular, it is sleeved on the outside of the molding member 312, and resists against the molding member 312 and the light transmitting plate 310, so that the resisting member 12 and the light transmitting plate 310 cooperate to effectively clamp the molding member 312. This avoids deformation of the molding cavity 3141 due to injection of an excess of the adhesive 3000, ensuring that shape of adhesive 3000 after being cured is uniform, improving product quality.

It can be understood that in other embodiments, the resisting member 12 may be a continuous or discontinuous ring. However, the resisting member 12 should resist against the molding member 312 at least, allowing the resisting member 12 to cooperate with the light transmitting plate 310 to effectively clamp the molding member 312.

It can be understood that in other embodiments, the resisting member 12 can be canceled.

In some embodiments, the first mold 11 includes a bottom mold 111 and a soft mold 112. The bottom mold 111 is substantially plate-shaped, and the bottom mold 111 can be made of one of plastic, metal, and silica gel. The bottom mold 111 defines a mounting site 1111. The mounting site 111 can be a blind hole and located substantially in the middle of the bottom mold 111. The bottom mold 111 has a protrusion portion 1112 arranged at a periphery of the mounting site 1111. The protrusion portion 1112 is substantially annular and surrounds the mounting site 1111. A portion of the resisting member 12 is sleeved on an outside surface of the protrusion portion 1112, and the other portion of the resisting member 12 resists against an outside surface of the molding member 312 and the light transmitting plate 310. The outside surface of the molding member 312 abuts against an inside surface of the protrusion portion 1112. An end surface of the molding member 312 abuts against the connecting bracket 2020 of the product, so that the molding cavity 3141, for containing the product and for injecting the adhesive 300, is formed between the molding cavity 3122 and the product. In this way, the protrusion portion 1112, the resisting member 12, and the light transmitting plate 310 cooperate with each other to support and press against the molding member 312, ensuring that the molding member 312 will not be deformed by the pressure of adhesive 3000 injected into it.

For ease of illustration, in the embodiments of the present application, “inside” is defined as a side close to a center of the molding die 100, “outside” is defined as a side far away from the center of the molding die 100, and “end surface” may be understood as a surface between “inside” and “outside”.

The soft mold 112 is substantially plate-shaped. The soft mold 112 may be made of elastic materials such as rubber or silica gel. The soft mold 112 is arranged in the mounting site 1111, and the soft mold 112 is configured to elastically support the display screen 2010 of the product. In this way, the soft mold 112 is arranged to prevent the display screen 2010 from being scratched, impacted, or crushed when the first mold 11 and the second mold 22 are clamped together.

It can be understood that in other embodiments, the mounting site 1111 can be a through hole, and the soft mold 112 is disposed in the mounting site 1111.

In some embodiments, a spacing groove 113 is formed between the protrusion portion 1112 and the soft mold 112. The molding member 312 includes a first molding portion 3123, a molding bottom 3124, and a second molding portion 3125 sequentially connected and forming the molding groove 3122. It can be understood that, the molding main body 3121 includes the first molding portion 3123, the molding bottom 3124, and the second molding portion 3125 sequentially connected and forming the molding groove 3122. The first molding portion 3123, the molding bottom 3124, and the second molding portion 3125 are all annular, and a height of the second molding portion 3125 is higher than that of the first molding portion 3123. The second molding portion 3125 is inserted in the spacing groove 113. A part of the outside surface of the second molding portion 3125 resists against the inside surface of the protrusion portion 1112, the other part of the outside surface of the second molding portion 3125 resists against the resisting member 12, the inside surface of the second molding portion 3125 resists against the outside surface of the display screen 2010, and the end surface of the first molding portion 3123 resists against the upper surface of the connecting bracket 2020. In this way, the display screen 2010, the connection bracket 2020, the first molding portion 3123, the molding bottom 3124, and the second molding portion 3125 cooperate with each other to form the molding cavity 3141. The molding cavity 3141 is configured to receive injections of the adhesive 3000, and the connecting bracket 2020 and the display screen 2010 will be firmly bonded after the adhesive 3000 is cured.

In some embodiments, the first mold assembly 10 further includes a sleeve plate 13 and a pair of handles 14. The sleeve plate 13 is configured to connect at least a part of a periphery of the light transmitting plate 310 and the second mold 22, to press the light transmitting plate 310 against the second mold 22. The sleeve plate 13 is substantially annular. The sleeve plate 13 can be sleeved on the resisting member 12, so that the sleeve plate 13 resists against the resisting member 12 on the one hand, and applies pressure on the light transmitting plate 310 of the molding die 30 for securing the light transmitting plate 310 in the second groove 223 of the second mold 22. Obviously, if the resisting member 12 is canceled, the sleeve plate 13 applies pressure on the light transmitting plate 310 of the molding die 30 for securing the light transmitting plate 310 in the second groove 223 of the second mold 22 only. The pair of handles 14 is rotatably disposed on opposite sides of the first mold 11. The pair of handles 14 are further detachably clamped on two sides of the second mold 22. In this way, the first mold 11 and the second mold 22 are clamped by means of the pair of handles 14, ensuring the stability of the first mold 11 and the second mold 22 after they are clamped.

In some embodiments, each handle 14 includes a rotating member 141, a rotating shaft 142, a handle body 143, a stop member 144, a second fastener 145, and an elastic assembly 146. The number of rotating members 141 of each handle 14 may be two. The two rotating parts 141 are respectively connected to two ends of the handle body 143. The number of rotating members 141 is equal to the number of rotating members 141. The two rotating members 141 are rotatably connected with a side of the first mold 11 through two rotating shafts 142. The handle body 143 is connected with the two rotating members 141. A side of the handle body 143 facing away from the rotating members 141 defines at least one stop groove 1431. In this embodiment, the number of stop grooves 1431 on one handle body 143 is two. In the exemplary embodiment, one stop groove 1431 and corresponding parts of the one stop groove 1431 are described. Obviously, the number of stop grooves 1431 may be one, three, four, or more.

It can be understood that in other embodiments, each handle 14 can include one, three, four, or more rotating members 141 which are connected with the handle body 143.

The stop member 144 is substantially in a shape of a block. The stop member 144 is fixedly arranged in the stop groove 1431 through the second fastener 145. The second fastener 145 can be a bolt. In this way, the first mold 11 and the second mold 22 are clamped by the pair of handles 14.

It can be understood that in other embodiments, an end of the second fastener 145 protrudes out of the stop member 144 after the second fastener 145 is fixed in the stop groove 1431 by the stop member 144. A bottom of each stop groove 1431 defines two elastic grooves 1432 which penetrate the handle body 143. An elastic assembly 146 is arranged in each elastic groove 1432. An end of the elastic assembly 146 resists against the stop member 144, and other end of the elastic assembly 146 protrudes out of the handle body 143. In this way, the handle 14 can elastically press against the second mold 22 through the elastic assembly 146.

The elastic assembly 146 includes an elastic member 1461 and a slidable member 1462. The slidable member 1462 is substantially spherical. Optionally, the slidable member 1462 is a steel ball. The elastic member 1461 and the slidable member 1462 lean against each other and are all located in the elastic groove 1432. A part of the slidable member 1462 protrudes out of the elastic groove 1432 to resist against a surface of the second mold 22. An end of the elastic groove 1432 facing away from the stop part 144 is substantially conical, so that a part of the slidable member 1463 protrudes out of the elastic groove 1432, and the other part stops in the elastic groove 1432.

Referring to FIG. 5, a side of the second mold 22 facing away from the first mold 11 defines a sliding groove 225. The sliding groove 225 can be strip-shaped or in another shape which fits the slidable member 1462. In this way, the slidable member 1462 is arranged to be spherical, so that the slidable member 1462 of the elastic assembly 16 can slid into the sliding groove 225 of the second mold 22. The slidable member 1462 supplies a force to squeeze the elastic member 1461 during the sliding, and the elastic member 1461 is compressed under the force and generates an elastic restoring force. When the slidable member 1462 slides into the sliding groove 225, the elastic restoring force is applied on the slidable member 1462 to make the slidable member 1462 tightly abut against the second mold 22, so that the pair of handles 14 can be easily clamped on the second mold 22, which is conducive to mold clamping of the first mold 11 and the second mold 22.

It can be understood that in other embodiments, the elastic assembly 146 may further include a connecting pad (not shown). The connecting pad may be annular, the connecting pad is connected with the elastic member 1461, and the slidable member 1462 is in movable contact with the connecting pad. In this way, the slidable member 1462 can roll during the sliding, thus reducing the friction between the slidable member 1462 and the second mold 22, which enables the sliding piece 1462 to slide into the sliding groove 225 of the second mold 22.

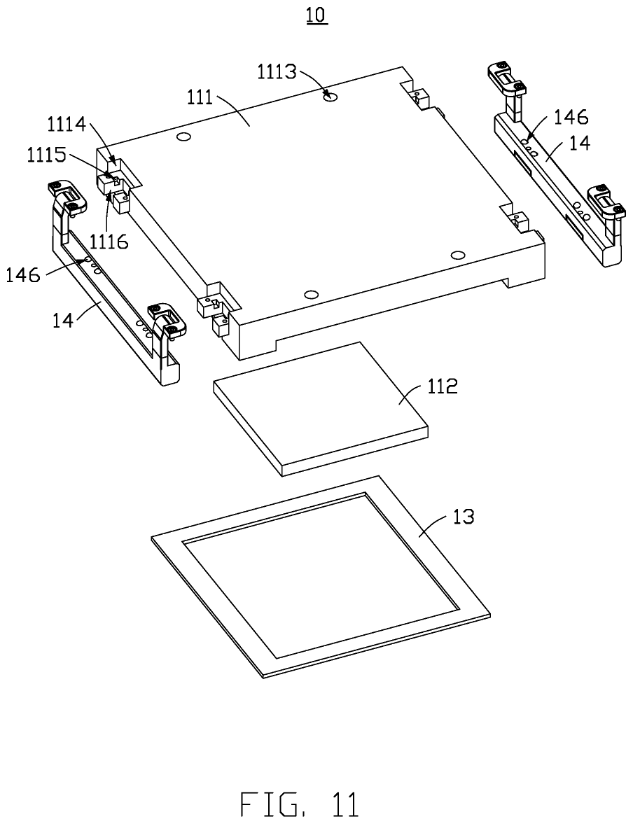

Referring to FIGS. 9 and 11, in some embodiments, each handle 14 further includes a rotation stop plate 147 and a third fastener 148. The rotation stop plate 147 is substantially U-shaped. A side of the first mold 11 facing away from the second mold 22 defines a rotation installation groove 1114. The number of rotation installation grooves 114 is equal to the number of rotating members 141, and the rotation installation grooves 114 are disposed to correspond to the rotating members 141. A bottom of each rotation installation groove 1114 defines a rotation hole 1116, which penetrates the second mold 22. The bottom of each rotation installation groove 1114 further defines two rotating shaft grooves 1115. The two rotating shaft grooves 1115 are located on both sides of the corresponding rotation hole 1116. The rotating shaft 142 is movably accommodated in and fits the rotating shaft grooves. The rotation stop plate 147 is fixed in the rotation installation groove 1114 through the third fastener 148, and the rotation shaft 142 is movably enclosed in the rotating shaft grooves 1115, thereby allowing a rotating connection between the handle 14 and the first mold 11.

In some embodiments, the third fastener 148 may be a bolt.

It can be understood that in other embodiments, after the third fastener 148 fixes the rotation stop plate 147 to the rotation mounting groove 1114, one end of the third fastener 148 protrudes out of the rotation stop plate 147. In this way, the first mold 11 is supported by a plurality of third fasteners 148, preventing scratches and impacts on a surface of the first mold 11 when the first mold 11 makes contact with an outside object, such as a machine table.

Referring to FIG. 8, it can be understood that in other embodiments, the first mold assembly 10 further includes a guide member 149. The first mold 11 defines a first connecting hole 1113, the second mold 22 defines a second connecting hole 224 corresponding to the first connecting hole 1113. There are four of each guide member 149, first connecting hole 1113, and second connecting hole 224. The guide member 149 can be a bolt, the first connecting hole 1113 and the second connecting hole 224 can be threaded holes. The guide member 149 extends into the first connecting hole 1113 and the second connecting hole 224 to connect the first mold 11 and the second mold 22. In this way, the first mold 11 and the second mold 22 can also be more tightly clamped by the guide members 149, the first connecting holes 1113, and the second connecting holes 224.

It can be understood that in other embodiments, the numbers of guide members 149, first connecting holes 1113, and second connecting holes 224 can be one, two, three, five, or more. The guide members 149 can be hinge pins, and the first connecting holes 1113 and the second connecting holes 224 can also be pin insertion-holes. By matching the guide member 149, the first connecting hole 1113, and the second connecting hole 224, when the first mold 11 and the second mold 22 are clamped, one end or both ends of the guide member 149 can protrude relative to the first mold 11 and/or the second mold 22 to support the first mold 11 and/or the second mold 22. In this way, the second fastener 145 and the third fastener 148 do not protrude out of the second mold 22 and the first mold 11.

It can be understood that in other embodiments, the first mold assembly 10 may include the guide member 149 and the pair of handles 14, or may include the guide member 149 or the pair of handles 14.

An assembly process of the molding die 100 according to some embodiments is generally as follows. First, the mold core 30 is accurately mounted in the second groove 223 of the second mold 22 by aligning the positioning member 24 and the positioning sleeve 311 of the mold core 30. Then, the resisting member 12 is sleeved on the outside surface of the molding member 312, and the resisting member 12 resists against the light transmitting plate 310. Then, the sleeve plate 13 is connected with the second mold 22 and sleeved on the outside surface of the resisting member 12, and the sleeve plate 13 applies a pressure on the light transmitting plate 310 to secure the light transmitting plate 310 into the second groove 223 of the second mold 22. Then, the product is mounted on the mold core 30, so that the connecting bracket 2020 of the product resists against the first molding portion 3123, and the display screen 2010 resists against the second molding portion 3125 to form the molding cavity 3141. Then, the soft mold 112 is mounted in the mounting site 1111 of the first mold 11. Then, the first mold 11 equipped with the soft mold 112 is mounted on the second mold 22 by matching the guide member 149, the first connecting hole 1113, and the second connecting hole 224, to implement mold clamping. Then, the pair of handles 14 are rotated, so that the first mold 11 and the second mold 22 press against the product, that is, the display screen 2010 presses against the soft mold 112, and the connecting bracket 2020, the display screen 2010, and the molding groove 3122 are pressed to form a sealed molding cavity 3141. Then, the light guide 23 is mounted in the through hole 221 of the second mold 22. Then, the pressing plate 25 is mounted in the first groove 222. The clamping of the first mold 11, the second mold 22, and the mold core 30 is thus achieved. Then, a needle 300 is passed through an inflow hole 231 of the light guide 23 and an injecting hole 3161 of an injecting portion 316, and the adhesive 3000 is injected into the molding cavity 3141 until the adhesive 3000 overflows from the overflow hole 3171. Then, the needle 300 is pulled out, a rubber plug can be passed through the inflow hole 231 and be inserted into the injecting hole 3161, and a rubber plug can be passed through the light guide 23 and be inserted into the overflow hole 3171, so as to seal the injecting hole 3161 and the overflow hole 3171. Then, the light source 200 is powered on, so that the incident light of the light source 200 passes through the light transmitting area to irradiate the adhesive 3000 in the molding cavity 3141 until the adhesive 3000 is cured to form the adhesive layer. Then, the light source 200 is powered off, the first mold assembly 10 and the second mold assembly 20 are disassembled, and the product with adhesive 3000 duly cured is taken out. In this way, the bonding between the display screen 2010 and the connecting bracket 2020 is implemented, the adhesive 3000 can be quickly cured under the irradiation of light, so that the curing time of the adhesive 3000 is reduced, the curing efficiency of the adhesive 3000 is improved, the production efficiency is high, and shape of formed adhesive 3000 is uniform, and the product quality is improved.

Referring to FIG. 12, a molding apparatus 1000 according to embodiments of the present application is illustrated. The molding apparatus 1000 includes a carrier table (not shown), a power supply (not shown), the light source 200, and the molding die 100 described above. The carrier table is configured to carry the molding die 100, the power supply is electrically connected with the light source 200, and the light source 200 is configured to emit ultraviolet, blue light or other light. The light source 200 in the figures is columnar, and is only for illustration. The light source 200 may be other than columnar in practice, and a shape of the light source 200 can be designed according to needs. The light emitted from the light source 200 irradiates the molding cavity 3141 through the light transmission area of the second mold 22, which rapidly solidifies the adhesive 3000 in the molding cavity 3141, so that the curing time of the adhesive 3000 is reduced, the curing efficiency of the adhesive 3000 is improved, the production efficiency is high, and the shape of the formed adhesive 3000 is uniform, the product quality is improved.

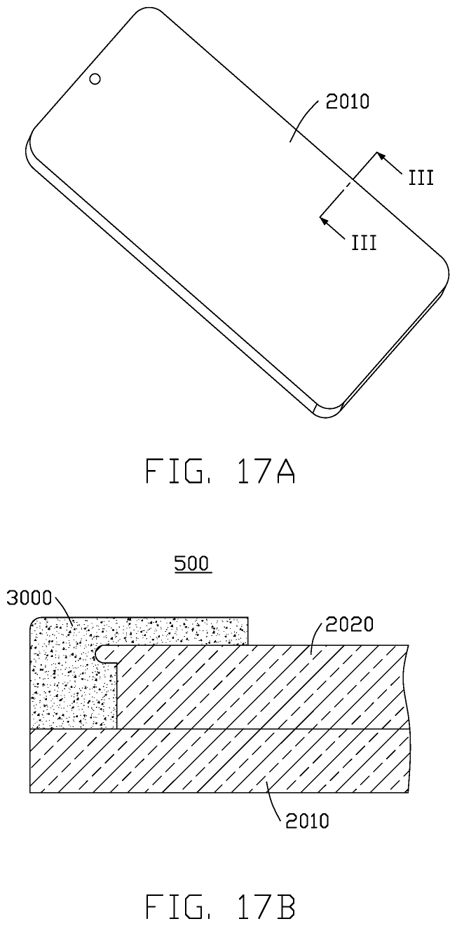

Referring to FIG. 17A and 17B, some embodiments of the present application provide a terminal 500. The terminal includes a display screen 2010 and an adhesive layer.

The adhesive layer is formed on the display screen 2010 by injecting the adhesive 3000 into the molding die 100 described above and is followed by curing.

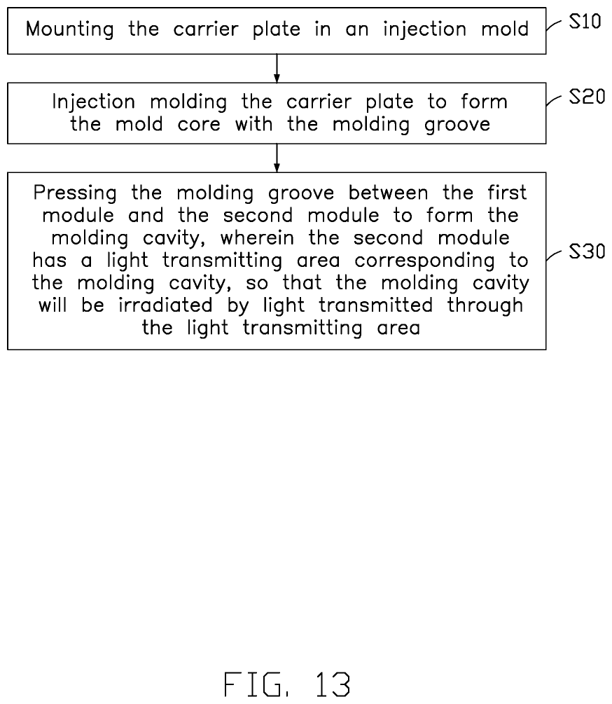

Referring to FIG. 13, some embodiments of the present application provide a manufacturing method of the molding die 100. The manufacturing method is configured to prepare the molding die 100 described above. The manufacturing method of the molding die 100 includes the following steps S10-S30.

S10, the carrier plate 31 is mounted in an injection mold 4000 (see FIG. 15).

S20, the carrier plate 31 is injection molded to form the mold core 30 with the molding groove 3122.

For example, the carrier plate 31 is first mounted in the injection mold 4000, then the carrier plate 31 in the injection mold 4000 is injection molded, so that the carrier plate 31 and the injection mold 4000 cooperate to form the mold core 30 with the molding groove 3122. The molding groove 3122 is formed by injection molding.

S30, the molding groove 3122 is pressed between the first mold assembly 10 and the second mold assembly 20 to form the molding cavity 3141. The second mold 22 has the light transmitting area corresponding to the molding cavity 3141, so that the molding cavity 3141 receives incident light through the light transmitting area.

For example, after the mold core 30 is pressed between the first mold assembly 10 and the second mold assembly 20, the molding groove 3122 fits with at least one of the product, the first mold assembly 10, and the second mold assembly 20 to form the molding cavity 3141 for injecting the adhesive 3000. In this way, after production of the molding die 100 is completed and the adhesive 3000 is injected, the light can pass through the light transmitting area to irradiate the adhesive 3000 in the molding cavity 3141, so that the adhesive 3000 can be cured rapidly under the irradiation of the light.

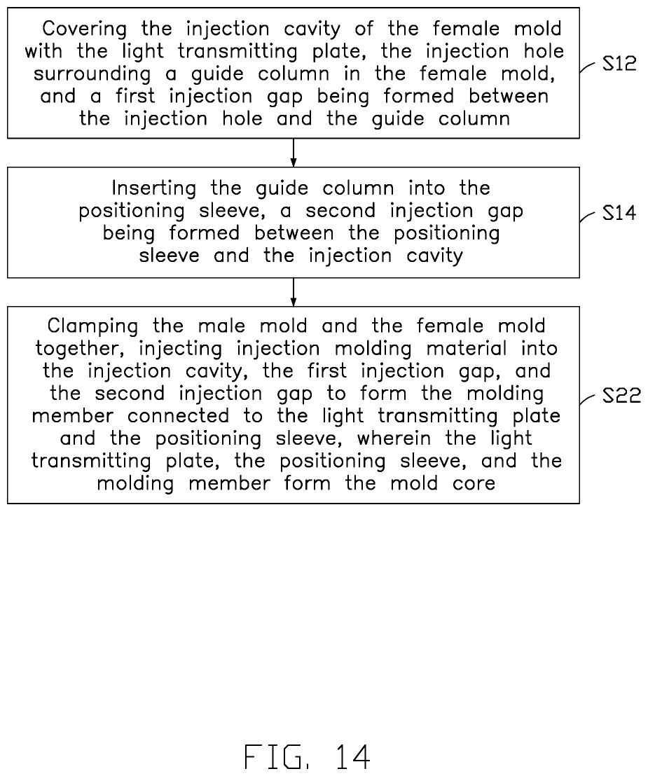

Referring to FIGS. 14 and 15, in some embodiments, the carrier plate 31 includes the positioning sleeve 311 and the light transmitting plate 310 with the injection hole 3101, and the injection mold 4000 includes a female mold 4010. Step S10 specifically includes the following steps S12 to S14.

S12, the injection cavity 4012 of the female mold 4010 is covered by the light transmitting plate 310, the injection hole 3101 surrounds a guide column 4014 in the female mold 4010, and a first injection gap is formed between the injection hole 3101 and the guide column 4014.

For example, the injection cavity 4012 of the female mold 4010 is configured to cooperate with the carrier plate 31 to form the mold core 30. The injection cavity 4012 of the female mold 4010 also has a function of positioning the light transmitting plate 310. The light transmitting plate 310 covers the injection cavity 4012 of the female mold 4010, the injection hole 3101 surrounds the guide column 4014, and the female mold 4010 positions the light transmitting plate 310, so that the first injection gap is formed between the injection hole 3101 and the guide column 4014.

S14, the guide column 4014 is inserted into the positioning sleeve, and a second injection gap is formed between the positioning sleeve and the injection cavity 4012.

For example, the positioning sleeve 311 is sleeved on the guide column 4014 and positioned in the first injection gap. A cap of the positioning sleeve 311 protrudes from the light transmitting plate 310. The second injection gap is formed between the cap and the injection cavity 4012. A part of the first injection gap accommodates the positioning main body 3132 of the positioning sleeve 311, and the other part of the first injection gap is configured for injection molding the positioning main body 3132 of the positioning member 313, and the second injection gap is configured to form the positioning cap 31211 of the positioning portion 313.

In some embodiments, the injection mold 4000 further includes a male mold 4020. Step S20 specifically includes the following step S22.

S22, the male mold 4020 and the female mold 4010 are clamped together, and injection molding material is injected into the injection cavity 4012, the first injection gap, and the second injection gap to form the molding member 312 connected to the light transmitting plate 310 and the positioning sleeve 311. The light transmitting plate 310, the positioning sleeve 311, and the molding member 312 forms the mold core 30.

For example, after the male mold 4020 and the female mold 4010 are clamped, the injection molding material is injected into the injection cavity 4012, the other part of the first injection gap, and the second injection gap to form the molding main body 3121, the positioning main body 3132, and the positioning cap 31211, The molding main body 3121, the positioning main body 3132, and the positioning cap 31211 form the molding member 312 connected to the light transmitting plate 310 and the positioning sleeve 311. The light transmitting plate 310, the positioning sleeve 311 and the molding member 312 form the mold core 30. After injection molding, the male mold 4020 and female mold 4010 are disassembled, and the mold core 30 is taken out.

FIGS. 13 to 14 illustrates a flowchart of the manufacturing method of the molding die 100. In the manufacturing method of the molding die 100, through the cooperation of the light transmitting plate 310, the positioning sleeve 311, and the injection mold 4000, the mold core 30 is formed in the injection mold 4000 by injection molding. The mold core 30 formed by injection molding has strong structure and high precision. Through the cooperation of the first mold assembly 10, the second mold assembly 20, and the mold core 30, the molding cavity 3141 for injecting the adhesive 3000 is formed. By exposing the molding cavity 3141 to the light transmitted through the light transmitting area, the adhesive 3000 can be quickly cured under the irradiation of light, so that the curing time of the adhesive 3000 is reduced, the curing efficiency of the adhesive 3000 is improved, the production efficiency is high, the shape of the formed adhesive 3000 is uniform, and the product quality is improved.

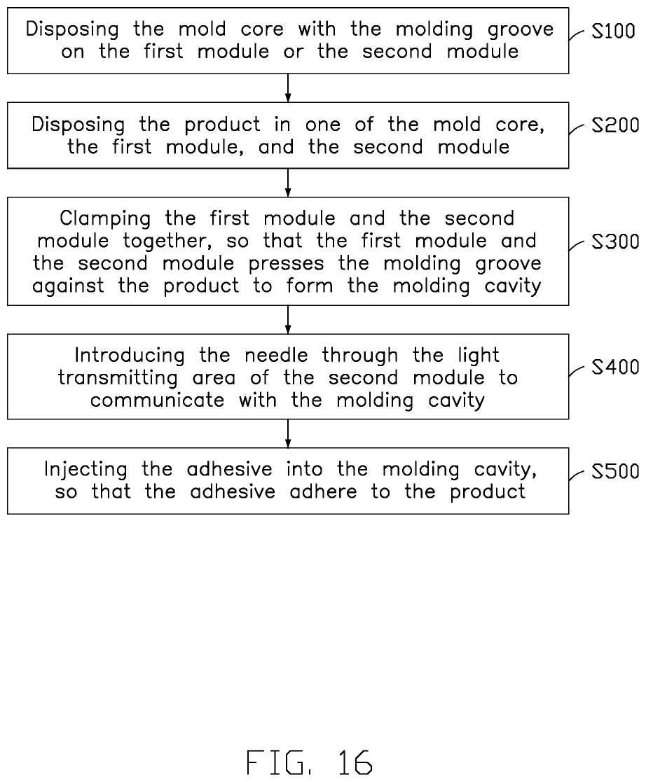

Referring to FIG. 16, some embodiments of the present disclosure provide a bonding method applied to a product, which uses the molding die 100 described above to inject the adhesive 3000 into the product. The bonding method applied to a product includes the following steps S100 to S500.

S100, the mold core 30 with the molding groove 3122 is disposed on the first mold assembly 10 or the second mold assembly 20.

For example, the mold core 30 manufactured by the manufacturing method described above or the molding die 100 manufactured by the manufacturing method hereinafter described is disposed on the second mold 22. In other embodiments, the mold core 30 with the molding groove 3122 can also be disposed on the first mold assembly 10. Certainly, when the last first mold assembly 10 and the second mold assembly 20 are mold-clamped, the molding groove 3122 forms the molding cavity 3141 with at least one of the product, the first mold assembly 10, and the second mold assembly 20.

S200, the product is disposed in one of the mold core 30, the first mold assembly 10, and the second mold assembly 20.

For example, the connecting bracket 2020 of the product and the display screen 2010 presses against the mold core 30. In other embodiments, the product may also be disposed on the first mold assembly 10 or the second mold assembly 20.

S300, the first mold assembly 10 and the second mold assembly 20 are clamped, so that the first mold assembly 10 and the second mold assembly 20 press the molding groove 3122 against the product to form the molding cavity 3141.

For example, the first mold assembly 10 and the second mold assembly 20 are clamped via the guide member and/or the pair of handles 14, so that the molding groove 3122 is attached to and presses against the product to form the molding cavity 3142.

S400, the needle 300 is introduced through the light transmitting area of the second mold assembly 20 to communicate with the molding cavity 3141.

For example, the needle 300 is passes through the inflow hole 231 of the light guide 23 of the second mold assembly 20 to communicate with the injection hole 3161 of the mold core 30, so as to facilitate the injection of adhesive 3000 into the molding cavity 3141.

S500, the adhesive 3000 is injected into the molding cavity 3141, so that the adhesive 3000 adhere to the product.

For example, the adhesive 3000 is injected into the molding cavity 3141 until the adhesive 3000 overflows from the overflow hole 3171. When the adhesive 3000 overflows from the overflow hole 3171, the needle 300 is pulled out, and rubber plugs are inserted into the injecting hole 3161 and the overflow hole 3171 to block the injecting hole 3161 and the overflow hole 3171. Light irradiates the adhesive 3000 in the molding cavity 3141, so that the adhesive 3000 is cured quickly, and the display screen 2010 and the connecting bracket 2020 in the product are thereby bonded.

FIG. 16 illustrates a flowchart of the bonding method applied to a product of the present application. In the bonding method applied to a product of an embodiment of the present disclosure, the molding cavity 3141 is formed through the cooperation of the product, the first mold assembly 10, the second mold assembly 20, and the mold core 30. After placing the product in the molding cavity 3141 and mold-clamping, the adhesive 3000 is injected into the molding cavity 3141 via the needle 300. After the adhesive 3000 is filled up the molding cavity 3141, the adhesive 3000 provides full bonding with the product. By exposing the molding cavity 3141 to the light transmitted through the light transmitting area, the adhesive 3000 can be quickly cured under the irradiation of light, reducing the curing time of the adhesive 3000.

To those skilled in the art, it is apparent that the present disclosure is not limited to the details of the above exemplary embodiments, and the present disclosure may be implemented with other embodiments without departing from the spirit or basic features of the present invention. Thus, in any event, the embodiments should be regarded as exemplary, and not limiting; the scope of the present disclosure is limited by the appended claims, and not by the above depictions. Thus, all variations intended to fall into the meaning and scope of equivalent components of the claims should be covered within the present disclosure.

The above embodiments of the present disclosure are not to limit the claims of this invention. Any use of the content in the specification or in the drawings of the present disclosure which produces equivalent structures or equivalent processes, or is directly or indirectly used in other related technical fields is covered by the claims in the present disclosure.

What is claimed is:

1. A molding die comprising:
a first mold assembly;
a second mold assembly, wherein the first mold assembly and the second mold assembly are adapted to be clamped together; and
a mold core defining a molding groove, wherein the mold core is pressed between the first mold assembly and the second mold assembly to form a molding cavity, wherein the second mold assembly comprises a light transmitting area corresponding to the molding cavity, so that the molding cavity to receive incident light through the light transmitting area.

2. The molding die of claim 1, wherein the mold core comprises:
a carrier plate arranged between the first mold assembly and the second mold assembly; and
a molding member connected to the carrier plate, the molding groove is defined in the molding member.

3. The molding die of claim 2, wherein the carrier plate comprises:
a light transmitting plate arranged between the first mold assembly and the second mold assembly, wherein the molding member is arranged on the light transmitting plate; and
a positioning sleeve arranged on the light transmitting plate and connected to the molding member.

4. The molding die of claim 3, wherein the molding member comprises:
a molding main body arranged on the light transmitting plate, wherein the molding groove is defined in the molding main body; and
a positioning portion protruding from the molding main body and connected to the light transmitting plate, wherein the positioning portion defines a positioning hole, the positioning sleeve is arranged in the positioning hole.

5. The molding die of claim 4, wherein the positioning portion comprises:
a positioning main body protruding from the molding main body and connected to the light transmitting plate; and
a positing cap connected to the positioning main body, wherein the positioning cap and the molding main body are respectively snap-fitted to opposite outer surfaces of the light transmitting plate, the positioning hole penetrates the positioning main body and the positioning cap;
the positioning sleeve comprises a positioning sleeve body and a sleeve cap, the positioning sleeve body is arranged in the positioning hole of the positioning main body;
and the sleeve cap is arranged in the positioning hole of the positioning cap and connected to the positioning sleeve body.

6. The molding die of claim 4, wherein the molding member further comprises:
an injecting portion arranged on the molding main body and defining an injecting hole in fluid communication with the molding groove; and
an overflow portion arranged on the molding main body and defining an overflow hole in fluid communication with the molding groove.

7. The molding die of claim 4, wherein an outside surface of the positioning sleeve defines an engagement groove, a side wall of the positioning hole defines an engagement protrusion, the engagement groove engages with the engagement protrusion.

8. The molding die of claim 4, wherein the molding member is connected to the light transmitting plate and the positioning sleeve by injection molding.

9. The molding die of claim 3, wherein the second mold assembly comprises:
a second mold defining a through hole;
a light guide arranged in the through hole, wherein the light guide and the through hole cooperate to form the light transmitting area; and
a positioning member sequentially inserted through the second mold and the positioning sleeve.

10. The molding die of claim 9, wherein the second mold assembly further comprises a pressing plate arranged on the second mold and pressing against at least a part of a periphery of the light guide.

11. The molding die of claim 10, wherein the light guide is annular-shaped, sheet-shaped, or strip-shaped.

12. The molding die of claim 9, wherein the first mold assembly comprises:
a first mold supporting the molding member and fitted with the second mold;
a sleeve plate configured to connect with at least a part of a periphery of the light transmitting plate and the second mold, to press the light transmitting plate against the second mold; and
a pair of handles rotatably arranged on opposite sides of the first mold and detachably clamped on two sides of the second mold.

13. The molding die of claim 12, wherein the first mold comprises:
a bottom mold defining a mounting site and a protrusion portion arranged at a periphery of the mounting site; and
a soft mold arranged in the mounting site and configured to support a product;
wherein an outside surface of the molding member resists against an inside surface of the protrusion portion, an end surface of the molding member resists against the product, so that the molding groove and the product cooperate to form the molding cavity.

14. The molding die of claim 13, wherein a spacing groove is formed between the protrusion portion and the soft mold, the molding member comprises a first molding portion, a molding bottom, and a second molding portion sequentially connected and forming the molding groove, the second molding portion is inserted in the spacing groove, a part of an outside surface of the second molding portion resists against the inside surface of the protrusion portion, and an end surface of the first molding portion resists against an upper surface of the product.

15. A molding apparatus comprising:
a light source; and
a molding die comprising:
a first mold assembly;
a second mold assembly, wherein the first mold assembly and the second mold assembly are adapted to be clamped together, and
a mold core defining a molding groove, wherein the molding core is pressed between the first mold assembly and the second mold assembly to form a molding cavity;
the second mold assembly comprises a light transmitting area corresponding to the molding cavity, incident light of the light source irradiates the molding cavity through the light transmitting area.

16. A terminal, comprising a display screen and an adhesive layer, the adhesive layer is formed on the display screen by injecting adhesive into the molding die of claim 1 and is followed by curing.
